(19) United States
(12) Patent Application Publication
(10) Pub. No.: US 2011/0117315 A1
(43) Pub. Date: May 19, 2011

(54) TRUSS TYPE PERIODIC CELLULAR MATERIALS HAVING INTERNAL CELLS, SOME OF WHICH ARE FILLED WITH SOLID MATERIALS

(76) Inventors: Ki Ju Kang, Jeollanam-do (KR); Jun Hyung Byun, Busan (KR)

(21) Appl. No.: 13/003,947

(22) PCT Filed: Sep. 24, 2008
(86) PCT No.: PCT/KR08/05672

§ 371 Date: Jan. 13, 2011

(30) Foreign Application Priority Data
Jul. 25, 2008 (KR) 10-2008-0072930

(51) Int. Cl. B32B 5/12; B32B 3/12

(52) U.S. Cl. 428/112

(57) ABSTRACT

Provided are three-dimensional truss type periodic cellular materials, wherein a plurality of internal cells are formed periodically and part of the internal cells are filled with solid material like as metal, ceramic, synthetic resin, or composite materials for the purpose of preventing buckling of the truss elements when external compressive or shear loads is applied to the truss structure. By filling only parts of internal cells provided in the truss with appropriate solid materials, the buckling of truss elements can be suppressed maximally and effectively, and even if the buckling accidentally occurs, the sharp decline of strength can be prevented so as to ensure sufficient structural stability of the truss type periodic cellular materials.

### TECHNICAL FIELD

The present invention relates to light cellular materials, especially to truss type periodic cellular materials. By filling parts of internal cells provided in the truss with appropriate solid materials, the buckling of truss elements can be suppressed maximally and effectively, and even if the buckling accidentally occurs, the sharp decline of strength can be prevented so as to ensure sufficient structural stability of the truss type periodic cellular materials.

### BACKGROUND ART

Generally, cellular materials refer to relatively light and high-strength material provided with numbers of internal cells therein.

Conventionally, resin foam, metal foam and sintered ceramic and the like are disclosed as such cellular materials and widely applied in diverse industrial field on demands. These cellular materials may be classified as open type or closed type according to whether internal cells provided therein communicate with each other or not.

Cellular materials of which the size, shape and arrangement of structure are uniform and regular are classified especially as periodic cellular materials.

Recently, materials with truss structure have been newly introduced as such periodic cellular materials (H. N. G. Wadley, N. A. Fleck, A. G. Evans, 2003, Composite Science and Technology, Vol. 63, pp. 2331-2343).

A truss structure may have mechanical properties equivalent to honeycomb lattice if it is precisely calculated so as to have optimized strength. Moreover, since the inside of such truss structure is hollow, those hollow spaces can be advantageously utilized as occasion demands. As a most general truss structure, a pyramid truss is illustrated in FIG. 1. The pyramid truss is configured such that four regular triangular lattices form inclined planes symmetrically around an apex and a regular tetragonal lattice forms a bottom (or top) plane. This type of pyramid truss can be advantageously used in forming a square plate structure.

As another truss structure illustrated in FIG. 1, an Octet truss has a structure in which body elements of regular tetrahedrons and regular octahedrons are combined alternately, and each plane of those body elements form an equilateral triangle (R. Buckminster Fuller, 1961, U.S. Pat. No. 2,986,241).

In the twenty first century, a Kagome truss as illustrated in FIG. 1 has been developed by transforming said Octet truss (S. Hyun, A. M. Karlsson, S. Torquato, A. G. Evans, 2003, Int J. of Solids and structures, Vol. 40, pp. 6989-6998).

Compared with the pyramid truss or Octet truss, the Kagome truss exemplified in FIG. 1 is known to have less anisotropy of strength, and is superior in resistance to buckling, stability against deformation after buckling and energy absorption capability.

Meanwhile, wires such as piano wires can be advantageously used in the field demanding mass production, easy fabricability and high strength. Recently, new methods for manufacturing truss type cellular materials using wires have been developed through the consideration of the above-mentioned properties of wires.

For example, methods for manufacturing the periodic cellular materials by using wires are disclosed in detail in Korean Registered Patent No. 0566729, 0633657, 0700212 and 0767186 and Korean Patent Application No. 2006-00119233. FIGS. 2 to 6 illustrate the shapes of periodic cellular materials manufactured by the technologies disclosed in the above-listed patents and patent application.

However, the truss type periodic cellular materials disclosed in the above-listed patents and patent applications are inclined to break themselves thorough buckling of the truss elements when they receive external compressive or shear loads.

Particularly, elastic buckling can occurs easily when the slenderness ratio of the truss elements is large, or wires of the truss are high-strength metal such as piano wire, or high-strength fibers or fiber reinforced plastic frequently used in composite materials. With such elastic buckling, the strength of the periodic material tends to be rapidly reduced. Accordingly, the truss type cellular materials adopting such high-strength wires, fibers or fiber reinforced plastic get to have less amount of stability and damping capacity for deformation energy, which are not enough to be used in structural frame.

Consequently, since truss type cellular materials disclosed in Korean Patent Registration No. 0708483 and Korean Patent Application No. 2006-0119233 are adopting wires as truss elements and theses wires should be inherently curved helical so as to form truss structure, they are more susceptible to the buckling, which needs to be solved.

### DISCLOSURE

### Technical Problem

It is an object of the present invention to provide truss type periodic cellular materials, wherein by filling parts of internal cells provided in the truss with appropriate solid materials, the buckling of truss elements can be suppressed maximally and effectively, and even if the buckling accidentally occurs, the sharp decline of strength can be prevented so as to ensure sufficient structural stability of the truss type periodic cellular materials.

### Technical Solution

The first invention of the present invention provides a three-dimensional truss type periodic cellular material in which a plurality of internal cells are formed periodically, characterized in that part of the internal cells are filled with solid materials.

According to the second aspect of the present invention, the internal cells may be periodically formed with same size, or two difference sizes.

According to the third aspect of the present invention, the internal cells may be periodically formed with same size, and the solid material may be filled into part of the infernal cells which is selected alternatively.

According to the fourth aspect of the present invention, the internal cells may be periodically formed with same size to form a regular hexahedral truss.

According to the fifth aspect of the present invention, the internal cells may be periodically formed with the two different sizes, and the solid materials may be filled into only the internal cells of the smaller size.

According to the sixth aspect of the present invention, the internal cells may be periodically formed with the two different sizes, and the truss type may be any one selected from the group consisting of a pyramid truss, an Octet truss, a Kagome truss, a quasi-Kagome truss woven with wires, or a quasi-Octet truss woven with wires.

According to the seventh aspect of the present invention, the solid materials may be formed by solidifying one of the materials selected from the group consisting of molten pastes for soldering or brazing, liquid synthetic resin or liquid metal.

### Advantageous Effects

The cellular materials according to the present invention, in which a plurality of internal cells are formed periodically and part of the internal cells are filled with solid material, have the following advantageous effects.

First, it is possible to suppress the buckling of the truss elements which occurs when the truss type periodic cellular material receives external compressive or shear loads. Also, it is possible to increase stability and damping capacity for deformation energy as a structural frame by preventing the strength of the periodic material from being rapidly reduced even after the buckling occurs.

Second, since all truss elements can be restricted one another even though only part of the internal cells are filled with the solid materials, the buckling of the truss elements can be suppressed maximally and the ratio of internal porosity can be maintained appropriately, at the same time.

Third, since the truss type periodic cellular materials can be manufactured with simple and known technologies such as soldering, brazing, and resin bonding, the production cost can be reduced and the mass production can be facilitated.

Fourth, mass production and cost reduction can be advantageous accomplished by adopting the method wetting the three-dimensional truss in the liquid synthetic resin or liquid metal and taking out of it as a method of filling part of the internal cells with solid material, in which method the liquid synthetic resin or liquid metal remains only in the smaller internal cells due to the weight, viscosity thereof and capillary phenomenon in the liquid state, and is solidified by natural/forced cooling or heating.

### DESCRIPTION OF DRAWINGS

FIG. 1 is an exemplary perspective view illustrating a 1-layer structure of a pyramid truss, an Octet truss, and a Kagome truss.

FIG. 2 is a perspective view illustrating a multi-layer quasi-Octet truss type periodic cellular material adopting wires as truss elements, which is disclosed in Korean Patent Registration No. 0566729.

FIG. 3 is a perspective view illustrating a 1-layer quasi-Octet truss type periodic cellular material adopting wires as truss elements, which is disclosed in Korean Patent Registration No. 0633657.

FIG. 4 is a perspective view illustrating a 1-layer truss type periodic cellular material adopting wires preformed in a coil spring shape, which is disclosed in Korean Patent Registration No. 0700212.

FIG. 5 is a perspective view illustrating a truss type periodic cellular material adopting wires as truss elements and disposed on the bottom panel, which is disclosed in Korean Patent Registration No. 0767186.

FIG. 6 is a perspective view illustrating a multi-layer quasi-Kagome truss type periodic cellular material adopting wires as truss element, which is disclosed in Korean Patent Application No. 2006-0119233.

FIG. 7 is an exemplary perspective view illustrating regular hexagonal truss type cellular material, wherein parts of internal cells are filled with solid materials.

FIG. 8 is an exemplary perspective view illustrating pyramid truss type cellular material, wherein parts of internal cells are filled with solid materials.

FIG. 9 is an exemplary perspective view illustrating Octet truss type cellular material, wherein parts of internal cells are filled with solid materials.

FIG. 10 is an exemplary perspective view illustrating Kagome truss type cellular material, wherein parts of internal cells are filled with solid materials.

FIG. 11 is an exemplary perspective view illustrating quasi-Kagome truss type cellular material adopting continuous wires as truss element, wherein parts of internal cells are filled with solid materials.

FIGS. 12 through 14 are flowcharts illustrating methods for manufacturing the cellular materials according to the embodiments of the present invention.

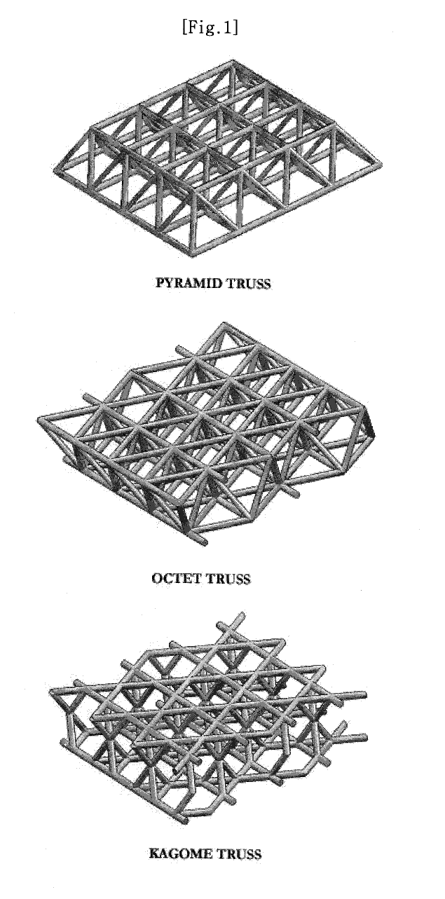

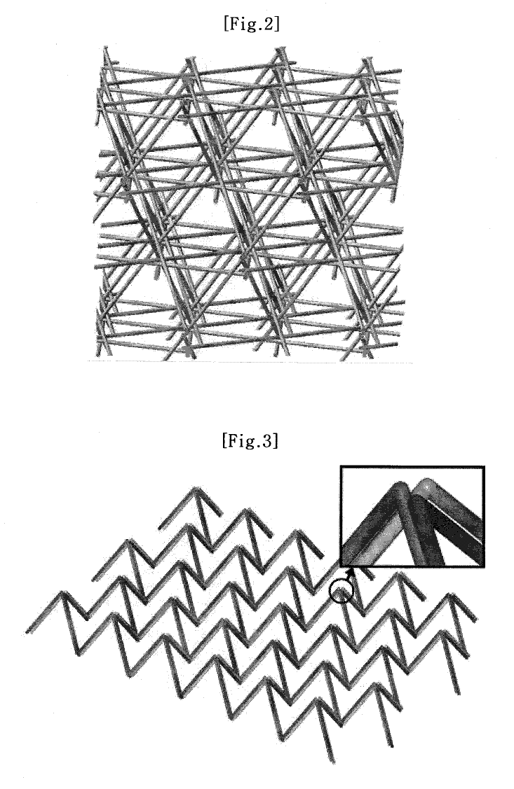

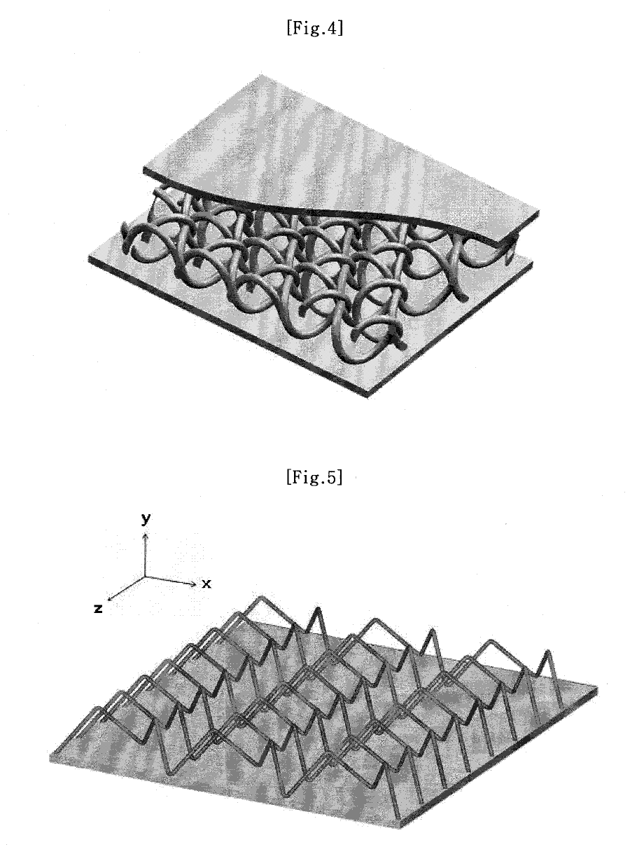

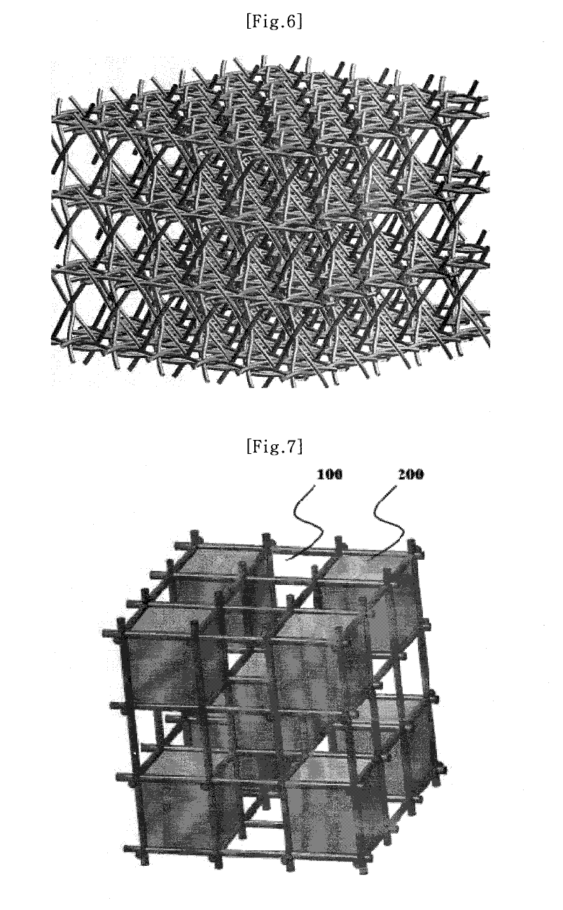

### MODE FOR INVENTION

Hereinafter, preferred embodiments of the present invention will be described in detail with reference to the accompanying drawings.

The present invention provides three-dimensional truss type periodic cellular material in which a plurality of internal cells is formed periodically, and parts of the internal cells are filled with solid material.

The solid materials filling part of the internal cells may be molten paste for soldering or brazing, liquid synthetic resin, metal, ceramic, or composite materials thereof.

In case paste for soldering or brazing is adopted as filling material for the internal cells, the paste may be preferably solidified by heating and melting the filler metal, which exists inside the paste, after the paste is disposed into part of the internal cells by injection.

Moreover, in case liquid synthetic resin or metal is adopted as filling materials for the internal cells, those filling materials may be naturally solidified with elapse of a predetermined time, or may be solidified by forced heating or cooling after they are disposed into part of the internal cells by injection.

In particular, in case the internal cells is provided in two different scales such as three-dimensional Kagome truss, part of the internal cells inside the truss can be filled with filling materials in the method that the truss is wetted in the liquid synthetic resin or metal and then taken out. In this method, the liquid synthetic resin or liquid metal can be induced to remain only in the smaller internal cells by controlling the properties of the filling materials themselves, e.g. the density, viscosity, surface tension and affinity to the truss element etc., and by utilizing capillary phenomenon. As mentioned above, once the filling materials are disposed into part of the internal cells, the filling materials may be solidified through natural/forced cooling or heating.

Filling solid materials into part of the internal cells, which exist periodically inside the three-dimensional truss type cellular material, may be carried out in a pattern as described below according to the embodiments of the present invention. In the embodiments according to the present invention, the internal cells may be periodically formed with same size or two different sizes. Herein, it is preferable that relatively small cells are filled with the solid materials rather than the big ones.

### First Embodiment

FIG. 7 is an exemplary perspective view illustrating regular hexagonal truss type cellular material, wherein parts of internal cells are filled with solid materials.

According to the first embodiment of FIG. 7, the internal cells 100 of which parts are selected alternatively one after another in the up, down, left and right direction are filled with the solid material 200.

Although the structural stability of a normal regular hexahedral truss is known as relatively low, the filled materials 200 according to the embodiment restrict all the truss elements so that the buckling of the truss elements themselves may be suppressed and that the structural stability of the whole cellular materials may be remarkably increased. Meanwhile, as quarter of the total internal cells is filled with solid materials, the porosity of the cellular material decreases in that degree.

As mentioned above, it is also preferable in this embodiment that the solid materials 200 filling part of the cells 100 may be selected from the group consisting of molten pastes for soldering or brazing, liquid synthetic resin or liquid metal.

### Second Embodiment

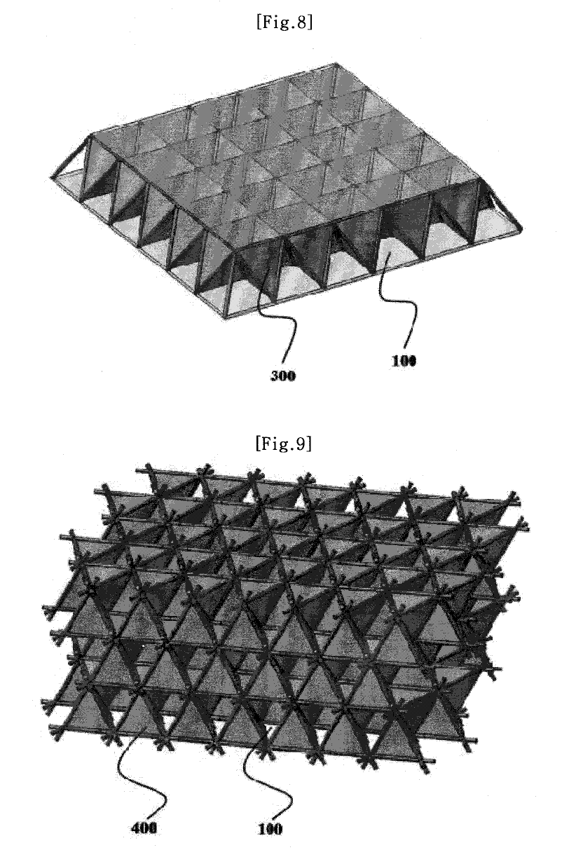

FIG. 8 is an exemplary perspective view illustrating pyramid truss type cellular material, wherein parts of internal cells are filled with solid materials.

According to the second embodiment of FIG. 8, only the tetrahedral cells among the pyramid and tetrahedral cells 100 constructing the pyramid truss are filled with the solid materials 300.

Since all truss elements are constrained by the solid materials, the structural stability of the truss elements themselves and the whole cellular material is remarkably increased.

On the contrary, about ⅓ of the whole volume of all the internal cells 100 are filled with the solid materials 300 and thus the porosity thereof is reduced as much.

In this embodiment, the solid materials 300 filling part of the cells 100 may be selected from the group consisting of molten pastes for soldering or brazing, liquid synthetic resin or liquid metal as mentioned in the preceding embodiment.

### Third Embodiment

FIG. 9 is an exemplary perspective view illustrating Octet truss type cellular material, wherein parts of internal cells are filled with solid materials.

According to the third embodiment of FIG. 9, only the tetrahedral cells among the regular octahedral cells and the tetrahedral cells 100 constructing the Octet truss are filled with the solid materials 400.

Since all truss elements are constrained by the solid materials 400, the structural stability of the truss elements themselves and the whole structure is remarkably increased.

On the contrary, about ⅓ of the whole volume of all the internal cells 100 are filled with the solid materials 400, and thus the porosity thereof is reduced as much. Also in this embodiment, the solid materials 400 filling part of the cells 100 may be selected from the group consisting of molten pastes for soldering or brazing, liquid synthetic resin or liquid metal as mentioned in the preceding embodiments, which are preferably inserted into the cells 100 by injection.

According to other feasible embodiment regarding the Octet truss, a quasi-Octet truss which is formed of wires and provided with octahedrons and quasi-regular tetrahedrons therein may be adopted as the truss type cellular material. In this case, the solid material may preferably fill only the internal cells in the shape of quasi-regular tetrahedrons.

### Fourth Embodiment

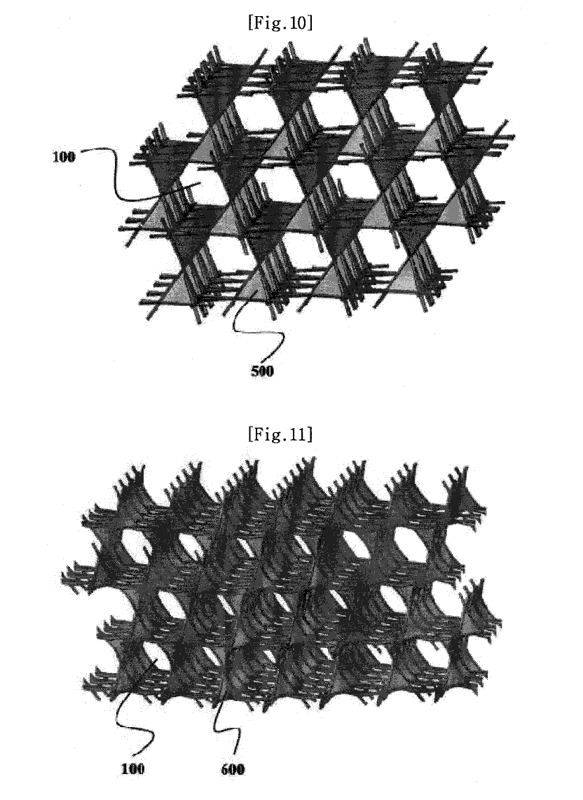

FIG. 10 is an exemplary perspective view illustrating Kagome truss type cellular material, wherein parts of internal cells are filled with solid materials.

According to the fourth embodiment of FIG. 10, only the tetrahedral cells among the octahedral cells and the regular tetrahedral cells 100 constructing the Kagome truss are filled with the solid materials 500.

Since all truss elements are constrained by the solid materials 500 like as the preceding embodiments, the structural stability of the truss elements themselves and the whole structure is remarkably increased.

In this embodiment, about 1/24 of the whole volume of all the internal cells 100 are filled with the solid materials 500, and thus the porosity thereof is reduced as much. The reduction ratio of porosity in this embodiment is more than those of the preceding first to third embodiments.

Similarly, the solid materials 500 filling part of the cells 100 may be selected from the group consisting of molten pastes for soldering or brazing, liquid synthetic resin or liquid metal as mentioned in the preceding embodiments, which are preferably inserted into the cells 100 by injection.

### Fifth Embodiment

FIG. 11 is an exemplary perspective view illustrating quasi-Kagome truss type cellular material adopting continuous wires as truss element, wherein parts of internal cells are filled with solid materials.

The quasi-Kagome truss according to the fifth embodiment of FIG. 11 may be constructed using continuous wires as disclosed in Korean Patent Registration No. 0708483 and Korean Patent Application No. 2006-0119233, and only the internal cells having shape similar to regular tetrahedrons is filled with solid materials 600, selectively.

Whereas the structure of the quasi-Kagome truss is inherently susceptible to buckling because the wires acting as the truss elements are subject to being curved, this buckling can be remarkable suppressed by partly filling the internal cells inside the truss with solid materials 600.

Similarly, the solid materials 600 filling part of the cells 100 may be preferably selected from the group consisting of molten pastes for soldering or brazing, liquid synthetic resin or liquid metal as mentioned in the preceding embodiments.

In particular with the quasi-Kagome truss, the separate boding process necessary to constrain the truss elements may be effectively omitted when the internal cells are partly filled with sol id materials.

The cellular materials according the preceding embodiments of the present invention may be manufactured as follows.

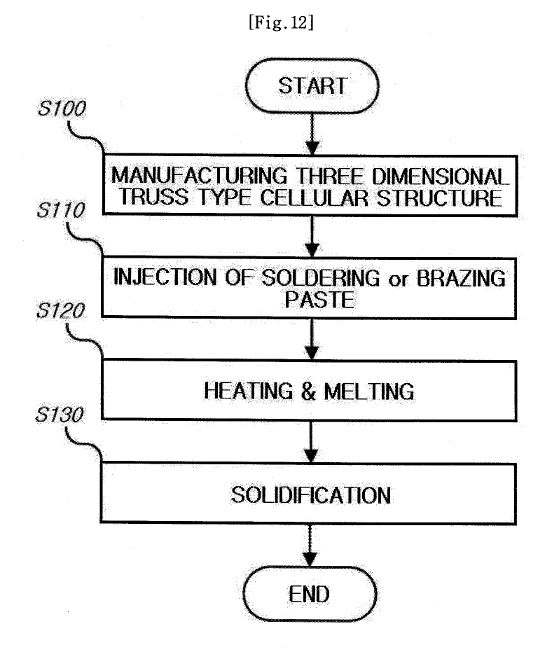

FIG. 12 illustrates the method for manufacturing the cellular materials according to the embodiments of the present invention, in which method pastes for soldering or brazing is used as the solid material for filling the internal cells. In the first step, a three-dimensional truss structure is constructed to have plurality of internal cells at the step S100.

Once the three-dimensional truss structure is prepared through the step S100, pastes for soldering or brazing is injected into part of the internal cells in any one pattern as disclosed in the above mentioned first to fifth embodiments of cellular materials at the step S110.

After pastes for soldering or brazing is injected into part of the internal cells through the step S110, it is heated to molten state at the step S120. At the step S120, the filler metal, which is included in the pastes, is heated and melted so that molten pastes may fill the corresponding internal cells without void.

At the next step, the cells filled with molten paste are naturally or artificially cooled so that the light three-dimensional truss type cellular materials may include periodic internal cells and acquire excellent resistance to buckling.

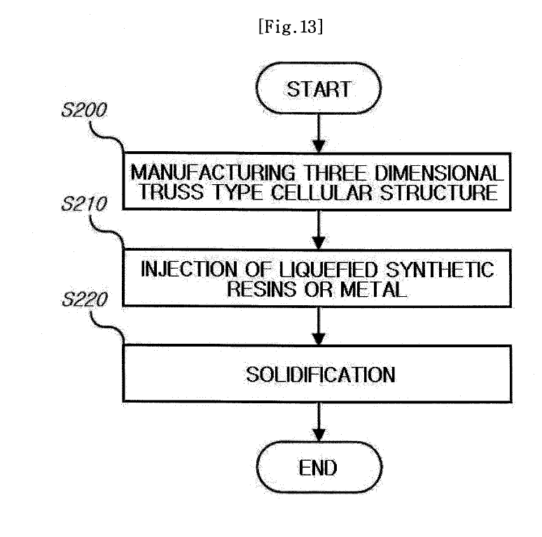

According to another embodiment of manufacturing the cellular materials of the present invention, liquid synthetic resin or liquid metal may be adopted as the solid material for filling the internal cells of the cellular materials, as shown in FIG. 13. Firstly, a three-dimensional truss structure is constructed to have plurality of internal cells at the step S200.

Once the three-dimensional truss structure is prepared through the step S200, liquid synthetic resin or liquid metal is injected into part of the internal cells in anyone pattern as disclosed in the above mentioned first to fifth embodiments of cellular materials at the step S210.

After liquid synthetic resin or liquid metal is injected into part of the internal cells through the step S210, it is naturally or artificially cooled to solidify at the step S220.

Flowingly, the light three-dimensional truss type cellular materials obtained through these steps may have periodic internal cells and acquire excellent resistance to buckling.

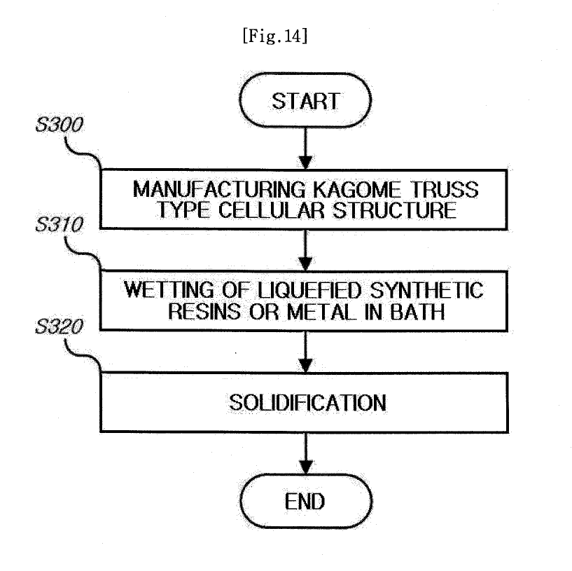

Meanwhile, in case the internal cells of the cellular materials are periodically formed with two different sizes such as Kagome truss, the three-dimensional truss type cellular materials according to the present invention may be obtained through a series of steps as shown FIG. 14, which comprise the step S300 preparing three-dimensional Kagome truss structure; the step S310 dipping the truss structure into liquid synthetic resin or liquid metal; and the step S320 solidifying the liquid synthetic resin or liquid metal remaining part of the internal cells after the truss structure is taken out from the liquid. The three-dimensional truss type cellular materials obtained in this way may be preferably provided with a group of cells with smaller size selectively filled with the solid materials.

In this case, the liquid synthetic resin or liquid metal can be induced to remain only in the smaller internal cells by controlling the properties of the filling materials themselves, e.g. the density, viscosity, surface tension and affinity to the truss element of Kagome truss structure etc., and by utilizing capillary phenomenon, as mentioned above.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A three-dimensional truss type periodic cellular material in which a plurality of internal cells are formed periodically, characterized in that part of the internal cells are filled with solid material.

2. The three-dimensional truss type periodic cellular material according to claim 1, wherein the internal cells are periodically formed with same size, or two difference sizes.

3. The three-dimensional truss type periodic cellular material according to claim 2, wherein the internal cells are periodically formed with same size, and the solid material are filled into part of the internal cells which is selected alternatively.

4. The three-dimensional truss type periodic cellular material according to claim 3, wherein the internal cells are periodically formed with same size to form a regular hexahedral truss.

5. The three-dimensional truss type periodic cellular material according to claim 2, wherein the internal cells are periodically formed with the two different sizes, and the solid materials are filled into only the internal cells of the smaller size.

6. The three-dimensional truss type periodic cellular material according to claim 5, wherein the internal cells are periodically formed with the two different sizes, and the truss type is any one selected from the group consisting of a pyramid truss, an Octet truss, a Kagome truss, a quasi-Kagome truss woven with wires, or a quasi-Octet truss woven with wires.

7. The three-dimensional truss type periodic cellular material according to claim 1, wherein the solid materials are formed by solidifying one of the materials selected from the group consisting of molten pastes for soldering or brazing, liquid synthetic resin or liquid metal.

8. The three-dimensional truss type periodic cellular material according to claim 3, wherein the solid materials are formed by solidifying one of the materials selected from the group consisting of molten pastes for soldering or brazing, liquid synthetic resin or liquid metal.

9. The three-dimensional truss type periodic cellular material according to claim 5, wherein the solid materials are formed by solidifying one of the materials selected from the group consisting of molten pastes for soldering or brazing, liquid synthetic resin or liquid metal.
